(19) United States
(12) Patent Application Publication
(10) Pub. No.: US 2014/0101551 A1
(43) Pub. Date: Apr. 10, 2014

(54) STITCHING VIDEOS INTO AN AGGREGATE VIDEO

(71) Applicant: GOOGLE INC., Mountain View, CA (US)

(72) Inventors: Doug Sherrets, San Francisco, CA (US); Murali Krishna Viswanathan, Paris (FR); Sean Liu, Sunnyvale, CA (US); Brett Rolston Lider, San Francisco, CA (US)

(73) Assignee: GOOGLE INC., Mountain View, CA (US)

(21) Appl. No.: 13/646,323

(22) Filed: Oct. 5, 2012

(51) Int. Cl. G06F 3/01

(52) U.S. Cl. 715/723

(57) ABSTRACT

Systems and methods for identifying sources associated with video clips uploaded by users and stitching those video clips into a single aggregate video according to a desired parameter and/or order. In particular, video clips uploaded by users can be matched to a source. Based upon processing of the video clip and/or source, a set of video clips with related content can be identified. That set of video clips can be ordered according to an ordering parameter. Overlapping and/or missing content can be identified, and the ordered set can be stitched into an aggregate video.

### TECHNICAL FIELD

This disclosure generally relates to stitching multiple videos together for constructing an aggregate video.

### BACKGROUND

Conventional content hosting sites or services typically host many video clips that are not adequately identified. Therefore, content consumers might easily fail to find interesting content, or might spend unnecessary time in attempts to locate certain content. For example, popular scenes from a particular episode of a show might be uploaded many times by different users. A content consumer interested in the entire episode of that show might be completely unaware of the context of the different scenes, how they relate to one another, and/or where the scene appears in the episode or show. A content consumer who chooses to watch all of the video clips will likely see the same content repeatedly and still might be unaware of certain information that might be beneficial.

As another example, a content consumer might be interested in Michael Jordan highlights. Upon searching for Michael Jordan content, the content consumer might be shown many lists of great plays by Michael Jordan, e.g., stitched by various users into “Top 10” or “Best” lists. In that case, the content consumer will likely be unaware of the actual sources for these lists and often will not know until actually viewing whether some or all of the content overlaps with other video clips the content consumer has already viewed. As a result, the content consumer might spend a great deal of time attempting to find interesting Michael Jordan highlights that are new.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems disclosed herein relate to identifying video clips uploaded by a user and stitching many video clips into a single aggregate video according to desired parameters. A content component can be configured to match a video clip uploaded to the server to a source (e.g., a source video). An identification component can be configured to identify a set of video clips with related content. An ordering component can be configured to order the set of video clips according to an ordering parameter. A stitching component can be configured to stitch at least a subset of the set of video clips into an aggregate video ordered according to the ordering parameter.

Other embodiments relate to methods for identifying video clips uploaded by a user and stitching many video clips into a single aggregate video according to a desired parameter. For example, media content that includes at least one video clip can be received. The at least one video clip can be matched to a source video and a collection of video clips that include content related to the at least one video clip can be identified. The collection of video clips can be organized according to an ordering parameter and at least a portion of the collection of video clips can be stitched into an aggregate presentation.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a high-level block diagram of an example system that can identify a source associated with video clips uploaded by users and stitch the video clips into a single aggregate video according to a desired parameter and/or order in accordance with certain embodiments of this disclosure;

FIG. 2A illustrates a block diagram of a system that can provide for additional features or detail in connection with the content component in accordance with certain embodiments of this disclosure;

FIG. 2B is a block illustration that depicts various examples of classification data in accordance with certain embodiments of this disclosure;

FIG. 3 illustrates a block diagram of a system that can provide for additional features or detail in connection with identification component in accordance with certain embodiments of this disclosure;

FIG. 4 illustrates a block diagram of a system that can provide for additional features or detail in connection with the ordering component in accordance with certain embodiments of this disclosure;

FIG. 5 illustrates a block diagram of a system that can provide for purchasing information and enhanced player presentation features in accordance with certain embodiments of this disclosure;

FIG. 6 is a block illustration relating to an example of source page in accordance with certain embodiments of this disclosure;

FIG. 7 illustrates a block diagram of a system that illustrates an example presentation of the aggregate video stitched from available clips in accordance with certain embodiments of this disclosure;

FIG. 8 illustrates an example methodology that can provide for identifying sources associated with video clips uploaded by users and stitching video clips into a single aggregate video according to a desired parameter and/or order in accordance with certain embodiments of this disclosure;

FIG. 9 illustrates an example methodology that can provide for additional features in connection with identifying sources and organizing video clips in accordance with certain embodiments of this disclosure;

FIG. 10 illustrates an example methodology that can provide for constructing a source page and/or providing advertisements, purchase information or other information into the aggregate representation in accordance with certain embodiments of this disclosure;

FIG. 11 illustrates an example schematic block diagram for a computing environment in accordance with certain embodiments of this disclosure; and

FIG. 12 illustrates an example block diagram of a computer operable to execute certain embodiments of this disclosure.

### DETAILED DESCRIPTION

### Overview

Systems and methods disclosed herein relate to identifying a source associated with video clips uploaded by users to a content hosting site or service. In some cases, the video clips can include content from many different sources (e.g., sports plays relating to a particular athlete from many different sources, popular scenes from a particular show, scenes from many different shows or films that include a particular actor, etc.), and in those cases the different sources can be identified.

By identifying the sources and providing that information to content consumers, more informed and efficient decisions can be made by those content consumers regarding which video clips to view or which sources to explore or purchase. To facilitate the above, a source page can be created for respective sources that includes a variety of information relating to the respective source. Video clips that include content from that source can be tagged with a reference to the source page so content consumers viewing the video clip can easily find additional information about the source and by proxy the video clip.

Once tagged with relevant information, video clips uploaded by users can be advantageously stitched together and the stitched, aggregate video can be viewed by users. For example, a publisher and/or content owner of a popular show might upload various video clips depicting scenes from the most recent episode of that show. Some of these scenes might include overlapping content and some of the content from the episode might not be included among the uploaded video clips. Suitable portions of the video clips can be stitched together into an aggregate video. In some embodiments, the aggregate video can be constructed to approximate the source video with overlapping portions (if any) removed and unavailable portions (if any) identified as such. In other embodiments, the aggregate video can be constructed to include, e.g., only scenes that include a particular actor or character, in which case the aggregate video can be ordered chronographically or according to another parameter.

### Tagging and Stitching Video Clips

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

It is to be appreciated that in accordance with one or more implementations described in this disclosure, users can opt-out of providing personal information, demographic information, location information, proprietary information, sensitive information, or the like in connection with data gathering aspects. Moreover, one or more implementations described herein can provide for anonymizing collected, received, or transmitted data.

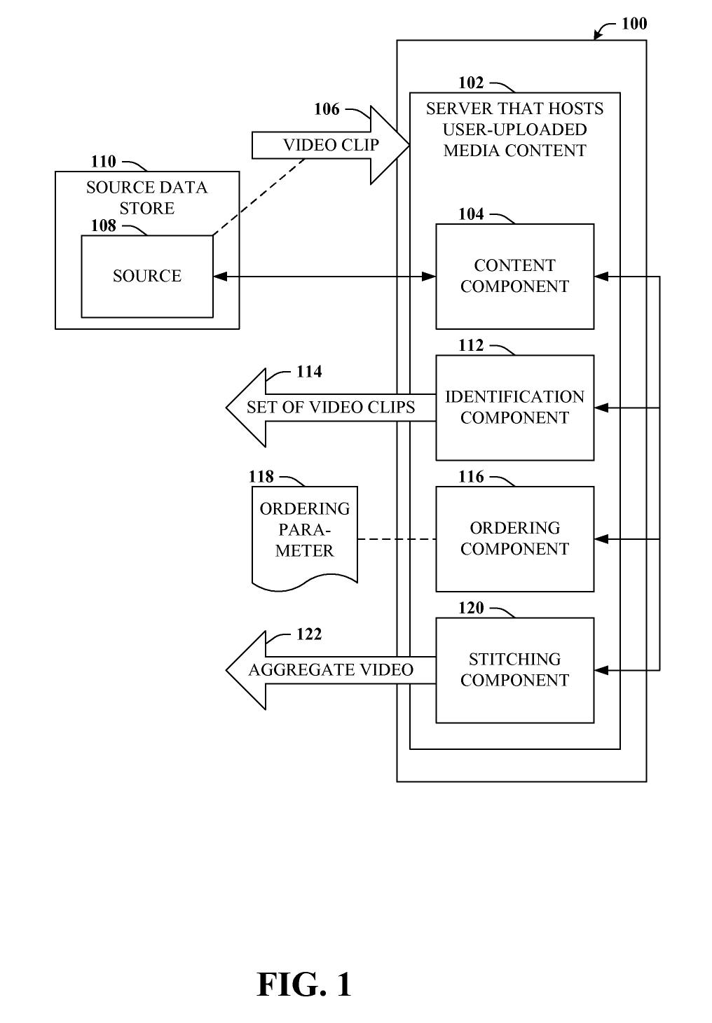

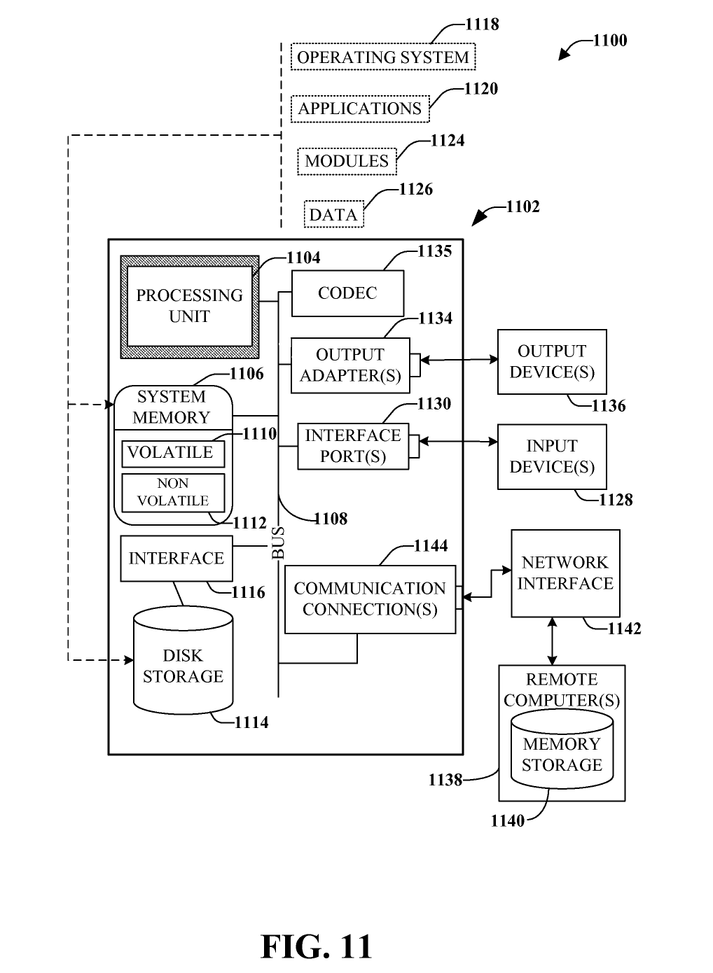

Referring now to FIG. 1, a system 100 is depicted. System 100 can identify a source associated with video clips uploaded by a user and stitch the video clips into a single aggregate video according to a desired parameter and order. As used herein, stitching can relate to appending portions of one video clip to another video clip, typically in a seamless manner, which can be accomplished by any suitable technique including merging video data or queuing different videos or portions of different videos into a playlist, etc. For example, the aggregate video can be a new video that combines data from multiple sources into a distinct video file or include elements of a playlist that address or access the multiple source video files sequentially. Embodiments disclosed herein, for example, can reduce the time and resources necessary to identify content that is of interest to content consumers and can provide additional information and opportunities to content owners. System 100 can include a server 102 that hosts user-uploaded media content. The server 102 can include a microprocessor that executes computer executable components stored in memory, structural examples of which can be found with reference to FIG. 11. It is to be appreciated that the computer 1102 can be used in connection with implementing one or more of the systems or components shown and described in connection with FIG. 1 and other figures disclosed herein. As depicted, system 100 can include a content component 104, an identification component 112, an ordering component 116, and a stitching component 120.

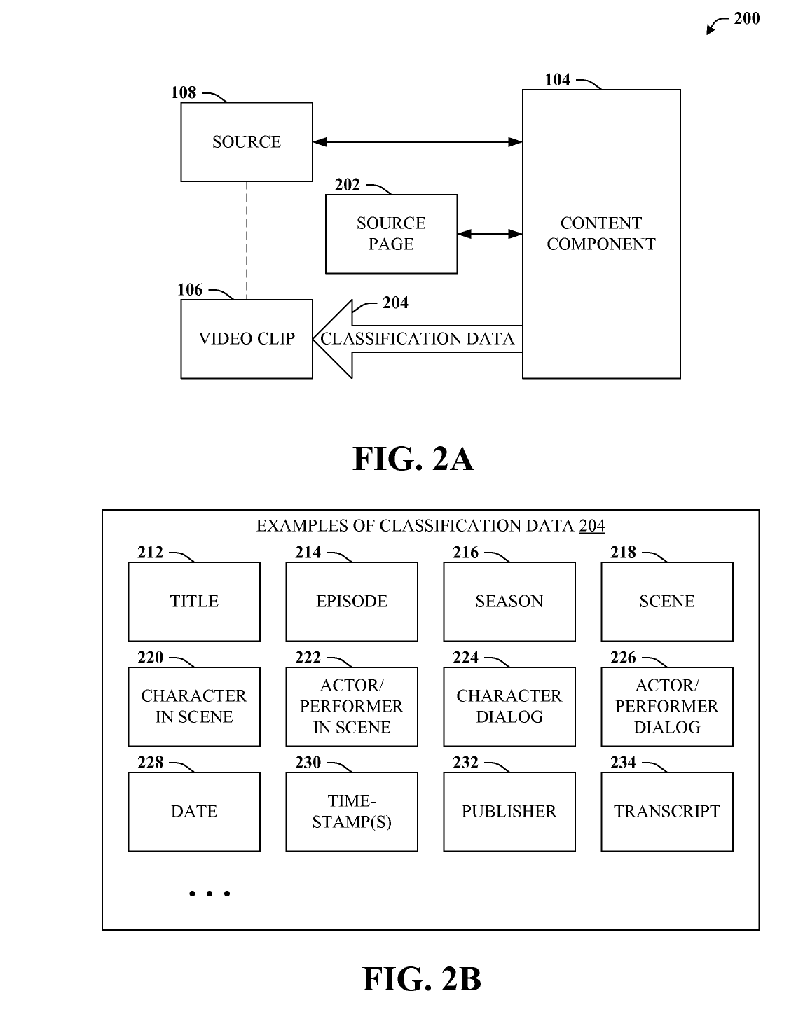

Content component 104 can be configured to match a video clip 106 uploaded to server 102 to a source 108. For example, if video clip 106 includes content from a film or televised show or event, then the film, televised show or event can be identified as source 108 based upon an examination of source data store 110 and/or comparison of video clip 106 to a sources included in source data store 110. Multiple sources 108 can be identified in scenarios where video clip 106 includes content from multiple sources. Content matching and other features associated with content component 104 can be found with reference to FIGS. 2A-2B

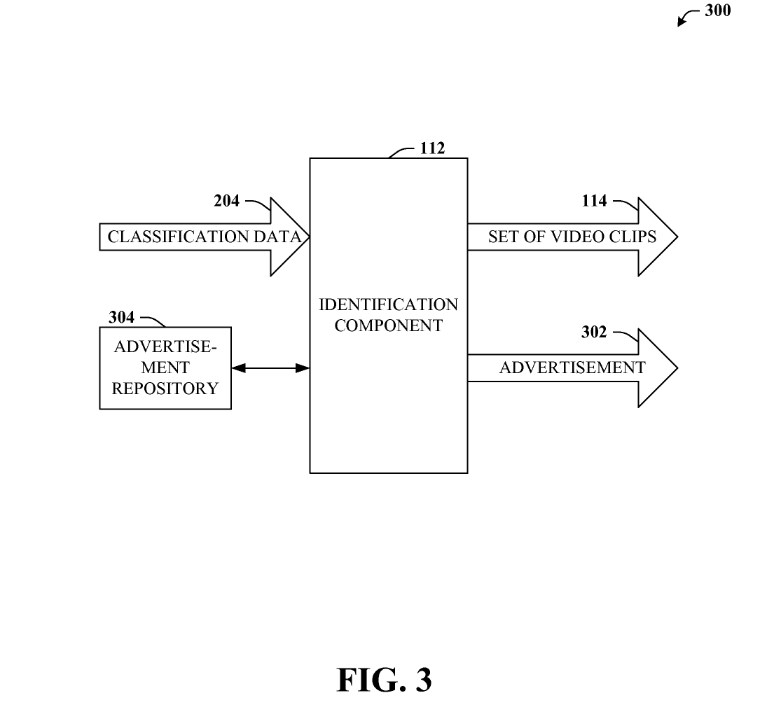

Identification component 112 can be configured to identify a set 114 of video clips with related content. For example, the video clips included in set 114 can be related to one another by virtue of including content from the same source(s) 108. Set 114 can include video clips that include content from the same program or show, are from the same publisher, have the same actor, etc., which is further detailed in connection with FIG. 3.

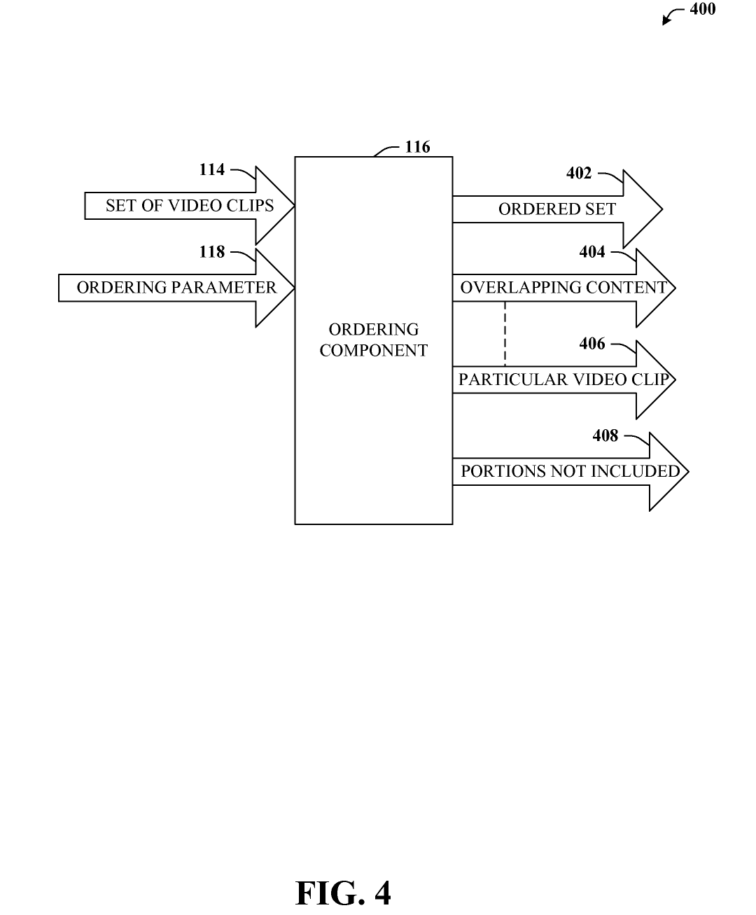

Ordering component 116 can be configured to order set 114 of video clips according to ordering parameter 118. For instance, set 114 of video clips can be ordered according to a source timestamp (e.g., running time within a given video presentation), chronologically (e.g., an original air date, an event date, etc.), popularity (e.g., a number of plays), or the like. Ordering parameter 118 can be selected by a content consumer or in some cases by a content owner or the uploader of video clip 106. In addition to setting ordering parameter 118, stitching of videos can be limited to authorized parties such as content owners, licensed entities, or authorized content consumers. Additional information relating to ordering component 116 can be found with reference to FIG. 4.

FIGS. 2A-4 are intended to be referenced in unison with FIG. 1 for additional clarity and/or to provide additional concrete examples of the disclosed subject matter. Turning now to FIG. 2A, system 200 is illustrated. System 200 provides additional features or detail in connection with content component 104. As previously detailed, content component 104 can match video clip 106 (uploaded to server 102) to source 108. Matching can be accomplished by way of any known or later discovered technique that is suitable for video content matching. In addition, alternatives to conventional matching schemes can be employed. For example, upon receiving video clip 106, content component 104 can generate a transcript of video clip 106 (or other classification data 204 further detailed with reference to FIG. 2B), which can be derived at least in part from closed-captioned text if included or based upon speech-recognition techniques. This transcript can be matched to transcripts for content included in source data store 110 to find a match. As transcripts are text-based, comparison can be performed in a manner that can be faster, more efficient in terms of resource utilization, and less likely to yield false positives than conventional image-based matching schemes.

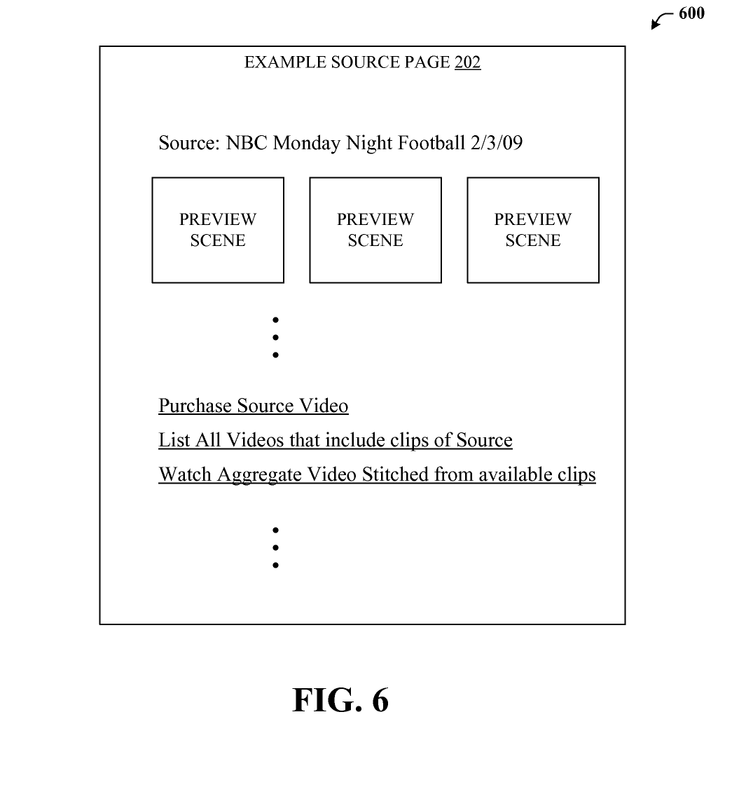

Once a match is found and source 108 identified, content component 104 can create source page 202. Source page 202 can include information particular to source 108. For example, source page 202 can include preview scenes (including those not included in video clip 106), purchase links, links to other video clips that include or reference source 108, one or more aggregate video 122, and so forth, which is further illustrated with reference to FIG. 6.

In some embodiments, content component 104 can identify various classification data 204. Much of classification data 204 can be extracted from source 108 and/or source page 202, and once identified, the classification data 204 can be included in video clip 106 (e.g., by tags or metadata) or included in an index associated with video clip 106. In some cases classification data 204 can be employed to facilitate matching source 108 such as in the case of creating a transcript of video clip 106. In other cases, classification data 204 can be applied to video clip 106 after source 108 has been discovered.

Referring now to FIG. 2B, various examples of classification data 204 are depicted. For instance, classification data 204 can relate to a title 212 of the source 208, an episode 214 associated with the source 208, a season 216 associated with the source 208, a scene 218 associated with the source 208, a character 220 included in scene 218, an actor or performer 222 included in scene 218, a character 224 reciting dialog, an actor or performer 226 reciting dialog (which can include a particular commentator or broadcaster), a date 228 of publication of the source 208, a timestamp 230 associated with the source 208, a publisher 232 associated with the source 208, or a transcript 234 associated with the video clip.

With reference now to FIG. 3, system 300 is illustrated. System 300 provides additional features or detail in connection with identification component 112. As previously described, identification component 112 can identify set 114 of video clips that include related content. In some embodiments, identification component 112 can identify set 114 of video clips with related content based upon classification data 204 provided by content component 104. For example, set 114 of video clips can include all or a portion of video clips uploaded that include content from a particular episode of a particular show or that include a scene of a particular performer speaking or appearing.

Set 114 of video clips can be determined in response to a user search that includes keywords, ordering parameter 118, or other desired parameters as well as a selection of a particular source page 202. For instance, a user might choose a particular source page 202 or a combination of source pages 202 to frame a search. Additionally or alternatively, the user might input “Michael Jordan,” “ESPN,” and “1991”. Results to this search can be set 114 of video clips, which in this case might include video clips of Michael Jordan that occurred in 1991 and were aired on ESPN. All or a portion of these search results can be stitched into a single video (e.g., aggregate video 122) that can be seamlessly presented to a user conducting the search or another user. The search might also include ordering parameter 118 that can designate the order of the individual videos that comprise aggregate video 122. For example, the video clips from set 114 can be ordered in aggregate video 122 according to chronological order, reverse chronological order, a total number of views or plays, a number of occurrences for a particular clip, and number of clip plays, etc. A user can choose to share aggregate video 122 or view aggregate videos 122 shared by other users. Optionally, aggregate videos 122 that are created by one user can be made available to other users by way of suggestions from certain users.

Navigating or presenting sources can be accomplished by combining sources, such as presenting all of the episodes or clips in a given show with scenes including a particular character or performer in a particular season. Users might also select some number of videos that result from a previous search and combine all of the content from those selected videos and only those selected videos into aggregate video 122.

In some embodiments, identification component 112 can identify an advertisement 302. Identification of advertisement 302 can be based upon preferences or selections by the uploader of video clip 106, by an advertiser, or based upon a particular content consumer or target audience. For example, an advertiser associated with sports drink company might select to advertise on NBA Finals videos that were originally broadcasted in the early 1990s. Assuming such is amenable to the content owner and/or uploader of a qualifying video clip and/or the content consumer, advertisements from the sports drink company can be identified in connection with aggregate videos 122 that include such content. Advertisement 302 can be selected from advertisement repository 304 and stitched into aggregate video 122, for example by stitching component 120.

Turning now to FIG. 4, system 400 is depicted. System 400 provides additional features or detail in connection with ordering component 116. As previously indicated, ordering component 116 can order set 114 of video clips according to ordering parameter 118. Ordered set 402 represents all or a portion of set 114 of video clips that are ordered according to ordering parameter 118. A given order can be based upon chronology or another factor.

In some embodiments, ordering component can identify overlapping content 404. For instance, consider a first video clip (included in set 114) that includes the first 5 minutes of a particular source 108 and a second video clip (included in set 114) that includes another 5 minute scene from that source 108, but begins 3 minutes into the runtime. In that case, the first video clip and the second video clip share 2 minutes of overlapping content 404. Ordering component 116 can select between the two video clips which video clip (e.g., particular video clip 406) will be stitched into the aggregate video. The selection can be based upon audio or video quality, licensing obligations, or other factors. If the first video clip is selected, then the first video clip can be stitched into the aggregate video 122 in its entirety, while the stitched portions of the second video clip will include only those 3 minutes not included in the first video clip. Hence, in response to multiple video clips from set 114 of video clips including overlapping content 404, ordering component 116 can select particular video clip 406 from among the multiple video clips to stitch into aggregate video 122 to present the overlapping content 404.

In some embodiments, ordering component 116 can identify portions of one or more sources 108 not included in set 114 of video clips and therefore content portions that cannot be included in aggregate video 122. Such is represented by portions not included 408. In that case, ordering component 116 can provide an indication that portions not included 408 are not available for presentation with respect to aggregate video 122.

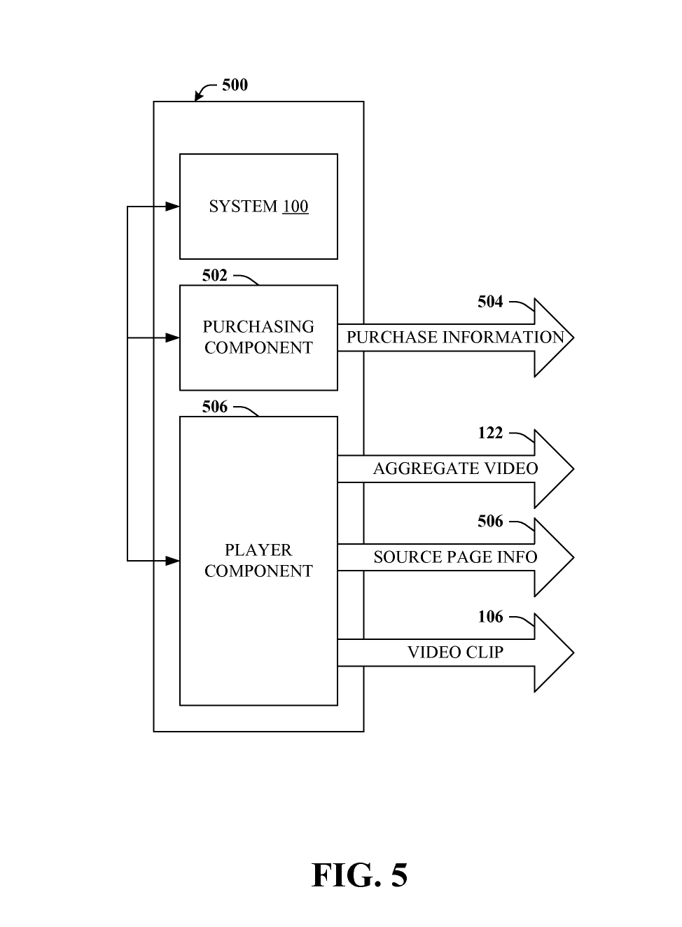

Turning now to FIG. 5, system 500 is depicted. System 500 provides for purchasing information and enhanced player presentation features. System 500 can include all or portions of system 100 as described previously or other systems or components detailed herein. In addition, system 500 can include purchasing component 502 and player component 506.

Purchasing component 502 can be configured to present purchase information 504 associated with source 108. For example, in cases where authorized and where the source 108 is available, then an option to purchase a copy of source 108 can be provided, e.g., in connection with presentation of video clip 106 or aggregate video 122 or other content that includes clips of source 108.

Player component 506 can be configured to present aggregate video 122 and information included in at least one source page associated with the aggregate video. For example, player component 506 can present various classification data 204 associated with any of the constituent video clips that comprise aggregate video 122 as well as a link to source page 202 or other relevant pages or data.

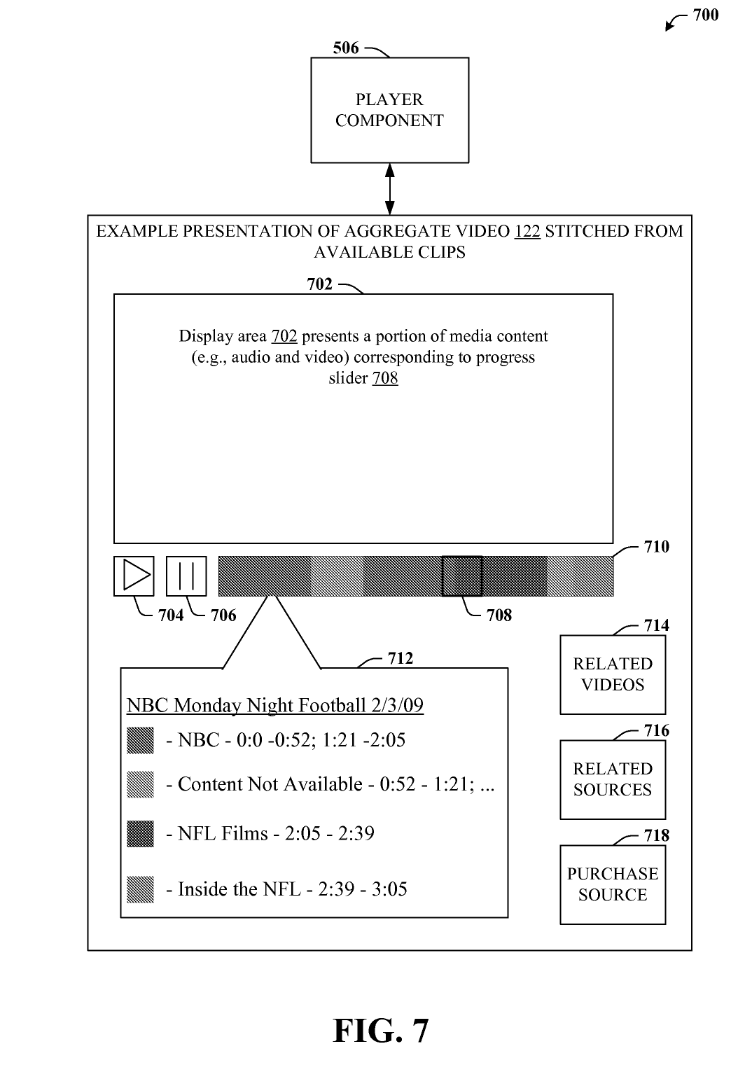

In some embodiments, player component 506 can provide color (or other) indicia for a progress bar associated with presentation of aggregate video 122. The color (or other) indicia can represent distinct sources 108 or distinct video clips from set 114 of video clips, which is further detailed in connection with FIG. 7.

Referring now to FIG. 6, example illustration 600 is provided. Example illustration 600 relates to an example of source page 202. In this example, the source (e.g., source 108) is identified as NBC Monday Night Football, which aired Feb. 3, 2009. Various (potentially clickable) preview scenes are also included in this example. In addition to other information related to this particular source, several links can be provided. For instance, a link to purchase the source can be provided as well as a link to list all videos that include clips of this source. Additionally, a link to watch or present aggregate video 122 stitched from available clips can be provided as well, an example of which can be found with reference to FIG. 7.

Turning now to FIG. 7, system 700 is depicted. System 700 illustrates an example presentation of aggregate video 122 stitched from available clips. A user interface associated with player component 506 can provide display area 702 that can present a portion of media content corresponding to progress slider 708. Below display area 702 are various controls including a play button 704, a pause button 706, and progress bar 710 that includes progress slider 708.

In response to certain input such as a click or mouse-hover, box 712 can be displayed that provides various details associated with aggregate video 122. In this example, one of the content owners is NBC, which originally broadcasted the game on the air date. NBC has uploaded a full version of the original source to server 102, which purchasers or other authorized parties can select. NBC has also uploaded numerous highlight video clips. In addition, other content owners or authorized parties have uploaded highlights of the game, including NFL Films and Inside the NFL. Stitching content from many different clips provided by these three different uploaders can result in aggregate video 122, which in this case can closely approximate the original broadcast.

In this example, progress bar 710 indicates the various different portions of the aggregate video 122 by color, including content not available from any of the available video clips and therefore cannot be presented in aggregate video 122 until or unless such content is uploaded to server 102 by some user. In some embodiments, related videos 714 information, related sources 716 information, and purchase source 718 information can be presented. It is understood that the information depicted in box 712 is merely an example and other information can be presented. For instance, box 712 can, additionally or alternatively, identify segments of aggregate video 122 based upon one or more classification data 204 parameter. As one example, mechanisms or techniques used for speaker identification can be employed, and aggregate video 122 can be divided into segments based upon various individuals (e.g., commentators, actors, or other performers) speaking. When aggregate video 122 is presented to a user, that user can navigate with the player controls to skip, pause, or move as appropriate, perhaps skipping specific speakers and/or focusing on other specific speakers.

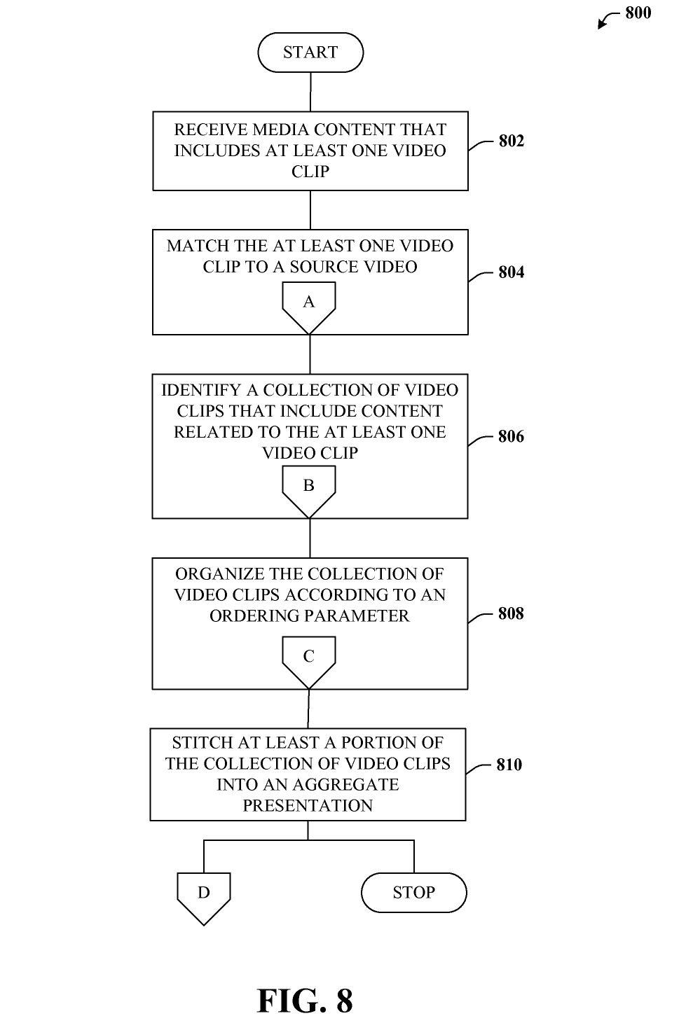

FIGS. 8-10 illustrate various methodologies in accordance with certain embodiments of this disclosure. While, for purposes of simplicity of explanation, the methodologies are shown and described as a series of acts within the context of various flowcharts, it is to be understood and appreciated that embodiments of the disclosure are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media.

FIG. 8 illustrates exemplary method 800. Method 800 can provide for identifying sources associated with video clips uploaded by users and stitching video clips into a single aggregate video according to a desired parameter and order. For example, at reference numeral 802, media content that includes at least one video clip can be received (e.g., by a server that hosts user-uploaded content).

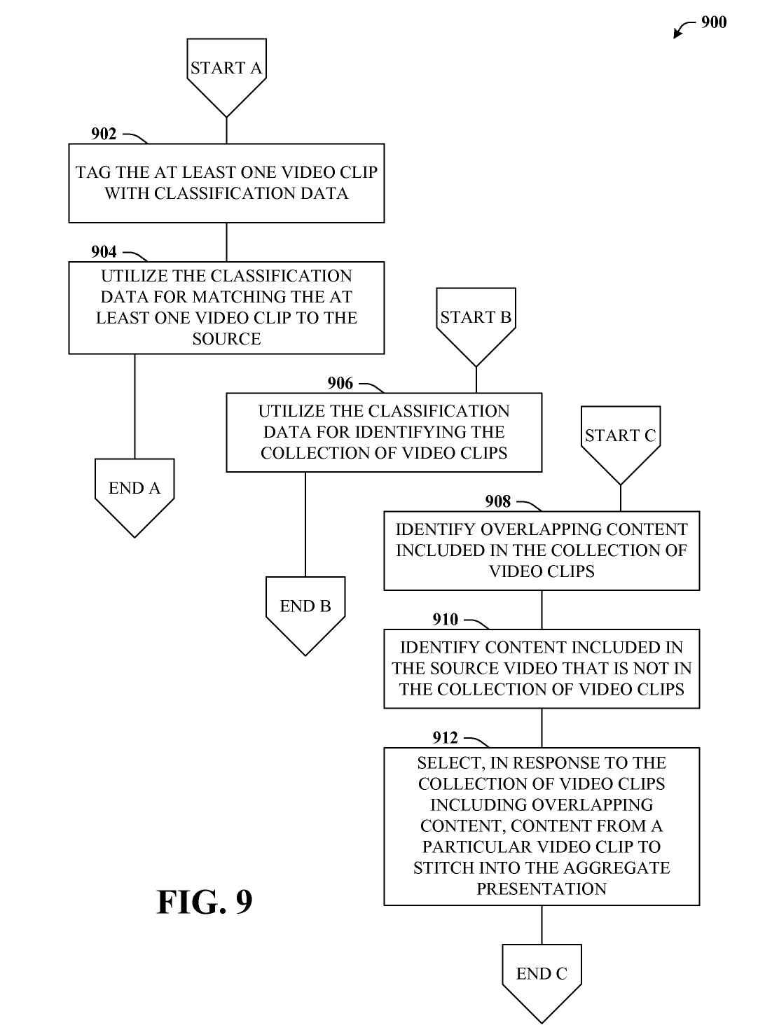

At reference numeral 804, the at least one video clip can be matched to a source (e.g., by a content component). The matching can be accomplished by way of image matching or any suitable matching technique in addition to those detailed herein. Method 800 can follow insert A (detailed with reference to FIG. 9) during or upon completion of reference numeral 804 or move directly to reference numeral 806. At reference numeral 806, a collection of video clips that include content related to the at least one video clip can be identified (e.g., by an identification component). The collection can be related to a single source or many sources. Method 800 can proceed to insert B (FIG. 9) during or upon completion of reference numeral 806 or to reference numeral 808.

At reference numeral 808, the collection of video clips can be organized according to an ordering parameter (e.g., by an ordering component). For example, the collection of video clips can be ordered based upon run times of the source, chronological order, number of plays or the like. Hence, a first clip relating to a scene from a particular show that occurs 10 minutes into the original version of the show can be ordered to precede a second clip relating to a different scene from the show that occurs 20 minutes into the original version. Additionally or alternatively, a scene involving a particular actor or performer that occurred in 1998 can be ordered to precede a second scene involving the same actor or performer that occurred in 2007.

During of upon completion of reference numeral 808, method 800 can proceed to insert C (FIG. 9) or traverse to reference numeral 810. At reference numeral 810, at least a portion of the collection of video clips can be stitched into an aggregate presentation (e.g., by a stitching component). Method 800 can then proceed to insert D or terminate.

Turning now to FIG. 9, exemplary method 900 is depicted. Method 900 can provide for additional features in connection with identifying sources and organizing video clips. Method 900 can begin at the start of insert A. For example, at reference numeral 902, the at least one video clip received in connection with reference numeral 802 can be tagged with classification data. By way of example, classification data at least one of a title of the source, an episode associated with the source, a season associated with the source, a scene associated with the source, a character included in the scene, an actor included in the scene, a character reciting dialog, an actor reciting dialog, a date of publication of the source, a timestamp associated with the source, a publisher associated with the source, or a transcript associated with the video clip.

In some cases, such as a transcript associated with the video clip, certain classification data can be determined prior to finding a match. In those cases, such classification data can be utilized for matching the at least one video clip to the source, which is detailed at reference numeral 904. In other cases, certain classification data is determined after a matching source is identified, such as for reference numeral 906. Method 900 can proceed to the end of insert A or traverse to reference numeral 906, by way of insert B.

At reference numeral 906, the classification data can be utilized for identifying the collection of video clips. For example, the collection of video clips can relate to a particular episode associated with the identified source or with a particular actor or performer associated with many difference sources. Method 900 can end insert B or proceed to reference numeral 908 by way of insert C.

At reference numeral 908, overlapping content included in the collection of video clips can be identified. At reference numeral 910, content included in the source video that is not in the collection of video clips can be identified. At reference numeral 912, a selection of content from a particular video clip can be made in response to the collection of video clips including overlapping content. The selection can be to choose which of the various video clips to use for stitching the overlapping content into the aggregate representation. Thereafter, method 900 and insert C can terminate.

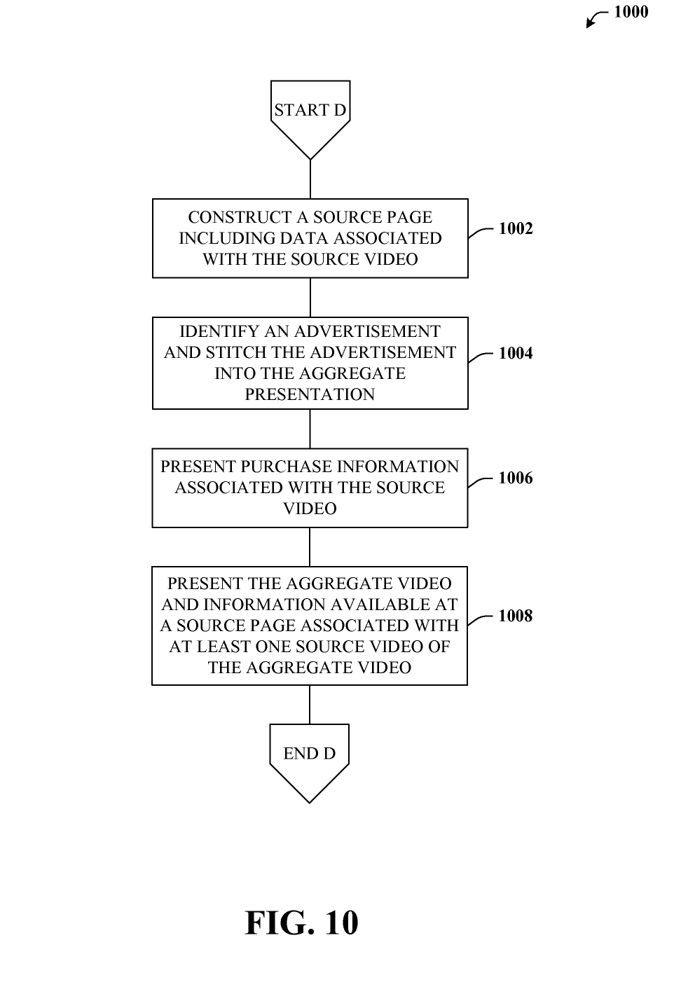

Turning now to FIG. 10, example method 1000 is illustrated. Method 1000 can provide for constructing a source page and including advertisements, purchase information and other information into the aggregate representation. Method 1000 can begin with the start of insert D, which proceeds to reference numeral 1002. At reference numeral 1002, a source page including data associated with the source video can be constructed.

At reference numeral 1004, an advertisement can be identified and the advertisement can be stitched into the aggregate presentation. At reference numeral 1006, purchase information associated with the source video can be presented. For instance, a link to a purchase screen can be provided or a link to the source page.

At reference numeral 1008, the aggregate video can be presented. Along with presentation of the aggregate video, additional information (e.g., from classification data, source page, etc.) can be presented as well.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

With reference to FIG. 11, a suitable environment 1100 for implementing various aspects of the claimed subject matter includes a computer 1102. The computer 1102 includes a processing unit 1104, a system memory 1106, a codec 1135, and a system bus 1108. The system bus 1108 couples system components including, but not limited to, the system memory 1106 to the processing unit 1104. The processing unit 1104 can be any of various available processors. Dual microprocessors and other multiprocessor architectures also can be employed as the processing unit 1104.

The system bus 1108 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1106 includes volatile memory 1110 and non-volatile memory 1112. The basic input/output system (BIOS), containing the basic routines to transfer information between elements within the computer 1102, such as during start-up, is stored in non-volatile memory 1112. In addition, according to present innovations, codec 1135 may include at least one of an encoder or decoder, wherein the at least one of an encoder or decoder may consist of hardware, software, or a combination of hardware and software. Although, codec 1135 is depicted as a separate component, codec 1135 may be contained within non-volatile memory 1112. By way of illustration, and not limitation, non-volatile memory 1112 can include read only memory (ROM), programmable ROM (PROM), electrically programmable ROM (EPROM), electrically erasable programmable ROM (EEPROM), or flash memory. Volatile memory 1110 includes random access memory (RAM), which acts as external cache memory. According to present aspects, the volatile memory may store the write operation retry logic (not shown in FIG. 11) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1102 may also include removable/non-removable, volatile/non-volatile computer storage medium. FIG. 11 illustrates, for example, disk storage 1114. Disk storage 1114 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1114 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1114 to the system bus 1108, a removable or non-removable interface is typically used, such as interface 1116. It is appreciated that storage devices 1114 can store information related to a user. Such information might be stored at or provided to a server or to an application running on a user device. In one embodiment, the user can be notified (e.g., by way of output device(s) 1136) of the types of information that are stored to disk storage 1114 and/or transmitted to the server or application. The user can be provided the opportunity to opt-in or opt-out of having such information collected and/or shared with the server or application (e.g., by way of input from input device(s) 1128).

It is to be appreciated that FIG. 11 describes software that acts as an intermediary between users and the basic computer resources described in the suitable operating environment 1100. Such software includes an operating system 1118. Operating system 1118, which can be stored on disk storage 1114, acts to control and allocate resources of the computer system 1102. Applications 1120 take advantage of the management of resources by operating system 1118 through program modules 1124, and program data 1126, such as the boot/shutdown transaction table and the like, stored either in system memory 1106 or on disk storage 1114. It is to be appreciated that the claimed subject matter can be implemented with various operating systems or combinations of operating systems.

A user enters commands or information into the computer 1102 through input device(s) 1128. Input devices 1128 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1104 through the system bus 1108 via interface port(s) 1130. Interface port(s) 1130 include, for example, a serial port, a parallel port, a game port, and a universal serial bus (USB). Output device(s) 1136 use some of the same type of ports as input device(s) 1128. Thus, for example, a USB port may be used to provide input to computer 1102 and to output information from computer 1102 to an output device 1136. Output adapter 1134 is provided to illustrate that there are some output devices 1136 like monitors, speakers, and printers, among other output devices 1136, which require special adapters. The output adapters 1134 include, by way of illustration and not limitation, video and sound cards that provide a means of connection between the output device 1136 and the system bus 1108. It should be noted that other devices and/or systems of devices provide both input and output capabilities such as remote computer(s) 1138.

Computer 1102 can operate in a networked environment using logical connections to one or more remote computers, such as remote computer(s) 1138. The remote computer(s) 1138 can be a personal computer, a server, a router, a network PC, a workstation, a microprocessor based appliance, a peer device, a smart phone, a tablet, or other network node, and typically includes many of the elements described relative to computer 1102. For purposes of brevity, only a memory storage device 1140 is illustrated with remote computer(s) 1138. Remote computer(s) 1138 is logically connected to computer 1102 through a network interface 1142 and then connected via communication connection(s) 1144. Network interface 1142 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1144 refers to the hardware/software employed to connect the network interface 1142 to the bus 1108. While communication connection 1144 is shown for illustrative clarity inside computer 1102, it can also be external to computer 1102. The hardware/software necessary for connection to the network interface 1142 includes, for exemplary purposes only, internal and external technologies such as, modems including regular telephone grade modems, cable modems and DSL modems, ISDN adapters, and wired and wireless Ethernet cards, hubs, and routers.

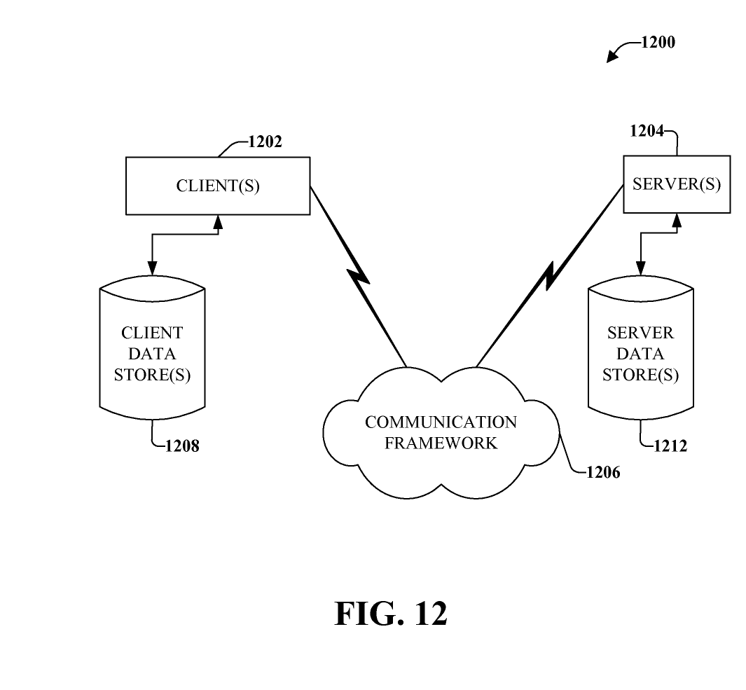

Referring now to FIG. 12, there is illustrated a schematic block diagram of a computing environment 1200 in accordance with this specification. The system 1200 includes one or more client(s) 1202 (e.g., laptops, smart phones, PDAs, media players, computers, portable electronic devices, tablets, and the like). The client(s) 1202 can be hardware and/or software (e.g., threads, processes, computing devices). The system 1200 also includes one or more server(s) 1204. The server(s) 1204 can also be hardware or hardware in combination with software (e.g., threads, processes, computing devices). The servers 1204 can house threads to perform transformations by employing aspects of this disclosure, for example. One possible communication between a client 1202 and a server 1204 can be in the form of a data packet transmitted between two or more computer processes wherein the data packet may include video data. The data packet can include a cookie and/or associated contextual information, for example. The system 1200 includes a communication framework 1206 (e.g., a global communication network such as the Internet, or mobile network(s)) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

In one embodiment, a client 1202 can transfer an encoded file, in accordance with the disclosed subject matter, to server 1204. Server 1204 can store the file, decode the file, or transmit the file to another client 1202. It is to be appreciated, that a client 1202 can also transfer uncompressed file to a server 1204 and server 1204 can compress the file in accordance with the disclosed subject matter. Likewise, server 1204 can encode video information and transmit the information via communication framework 1206 to one or more clients 1202.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

1. A system, comprising:
a server that hosts user-uploaded media content, the server including a microprocessor that executes the following computer executable components stored in a memory:
a content component that receives a video clip uploaded to the server and identifies a source for the video clip in response to a comparison of the video clip to the source resulting in a determined match;
an identification component that identifies a set of video clips with content that is related to the source;
an ordering component that orders the set of video clips according to an ordering parameter; and
a stitching component that stitches at least a subset of the set of video clips into an aggregate video ordered according to the ordering parameter.

2. The system of claim 1, wherein the content component creates a source page that includes information particular to the source.

3. The system of claim 1, wherein the content component tags the video clip with classification data relating to at least one of a title of the source, an episode associated with the source, a season associated with the source, a scene associated with the source, a character included in the scene, a performer included in the scene, a character reciting dialog, a performer reciting dialog, a date of publication of the source, a timestamp associated with the source, a publisher associated with the source, or a transcript associated with the video clip.

4. The system of claim 1, wherein the content component matches the video clip to the source based on a comparison of a transcript of the video clip to a transcript of the source.

5. The system of claim 1, wherein the identification component identifies the set of video clips with related content based upon classification data provided by the content component.

6. The system of claim 1, wherein the identification component identifies an advertisement, and the stitching component stitches the advertisement into the aggregate video.

7. The system of claim 1, wherein the ordering component, in response to multiple video clips from the set of video clips including overlapping content, selects a particular video clip to stitch into the aggregate video for the overlapping content.

8. The system of claim 1, wherein the ordering component identifies portions of the source not included in the aggregate video and provides an indication that the portions are not available for presentation.

9. The system of claim 1, further comprising a purchasing component that presents purchase information associated with the source.

10. The system of claim 1, further comprising a player component that presents the aggregate video and information included in at least one source page associated with the aggregate video.

11. The system of claim 10, wherein the player component provides color indicia for a progress bar associated with a presentation of the aggregate video, the color indicia representing distinct sources or distinct video clips from the set of video clips.

12. The system of claim 1, wherein the ordering parameter is based on at least one of a source timestamp, chronological ordering, reverse chronological ordering, or a popularity metric.

13. A method, comprising:
employing a computer-based processor to execute computer executable components stored within a memory to perform the following:
receiving media content that includes at least one video clip;
identifying a source video representing a content source of the at least one video clip based on a comparison of the at least one video clip to the source video;
identifying a collection of video clips that include content related to the source video;
organizing the collection of video clips according to an ordering parameter; and
stitching at least a portion of the collection of video clips into an aggregate presentation.

14. The method of claim 13, further comprising constructing a source page including data associated with the source video.

15. The method of claim 13, further comprising tagging the at least one video clip with classification data and utilizing the classification data for the identifying the collection of video clips.

16. The method of claim 13, further comprising identifying an advertisement and stitching the advertisement into the aggregate presentation.

17. The method of claim 13, further comprising selecting, in response to the collection of video clips including overlapping content, content from a particular video clip included in the collection to stitch into the aggregate presentation.

18. The method of claim 13, further comprising identifying content included in the source video that is not included in the collection of video clips.

19. The method of claim 13, further comprising presenting purchase information associated with the source video.

20. The method of claim 13, further comprising presenting the aggregate video and information available at a source page associated with at least one source video of the aggregate video.

21. A system, comprising:
means for receiving a video clip uploaded by a user;
means for identifying a source video representing a source of the video clip in response to a comparison of the source video to the video clip;
means for identifying a set of video clips that include content related to the source video;
means for ordering the set of video clips according to an ordering parameter; and
means for stitching at least a subset of the set of video clips into an aggregate video.
